(19) United States
(12) Patent Application Publication
(10) Pub. No.: US 2013/0010299 A1
(43) Pub. Date: Jan. 10, 2013

(54) TARGET DETECTION APPARATUS AND METHOD

(75) Inventors: Mark Edgar Bray, Basildon (GB); Jason Lepley, Basildon (GB)

(73) Assignee: Selex Galileo Limited, Basildon (GB)

(21) Appl. No.: 13/579,857

(22) PCT Filed: Jan. 24, 2011
(86) PCT No.: PCT/EP11/50917

§ 371 Date: Sep. 25, 2012

(30) Foreign Application Priority Data
Feb. 17, 2010 (GB) 1002709.2

(51) Int. Cl. G01N 21/55; G01N 21/64

(52) U.S. Cl. 356/445; 250/461.1; 250/216

(57) ABSTRACT

A target detection apparatus is described that is capable of improved detection of targets in urban environments or hidden in cluttered environments. The apparatus emits radiation in a modulated fashion, of a known wavelength, wavelengths or range of wavelengths and detects radiation returned by the targets in the environment.

The invention relates to target detection apparatus and methods. More specifically but not exclusively it relates to the detection of targets within a scene using an active electro optic sensor and method.

In a known apparatus and method a scene is illuminated with light of a predetermined wavelength and light reflected from the scene is incident on a light sensitive sensor. The targets are distinguished from the background of the scene by a physical property of the returned light. One particular known example is the detection of light returned to the sensor at a different frequency to that at which the light was emitted, which is caused by inelastic scattering of the light by the target. The frequency of the inelastically scattered light excited by the illuminating light and emitted by the target material is different to light scattered from background material; other phenomena examples include polarisation, Raman spectra and absorption lines.

The problem with this known technique is that the other light in the scene, such as reflected sunlight, may swamp the returning signal. Other methods to overcome this disadvantage may include filtering, and using a higher power light source. Use of a higher power light sources can cause safety and cost issues. Use of filtering may not reduce the noise sufficiently and may even limit the signal, whilst also increasing costs. If no mitigation is taken the useable range of operation will be limited.

According to the invention there is provided apparatus for detecting a target from within a scene comprising radiation-generating means for generating radiation and emitting said radiation toward the target, the radiation being of a known and predetermined wavelength, detector means for detecting the radiation returned by the target towards the detector, evaluation means for evaluating the radiation incident on the detector means wherein the detector means further includes a mechanism for modulating the emitted radiation such that the radiation reflected by the target may be more easily discriminated from background noise.

According to the invention there is further provided a method of detecting a target from within a scene comprising the steps of emitting radiation from a suitable radiation emitter; detecting radiation returned by the scene; discriminating the target from the scene by monitoring the returned radiation for responses characteristic of known target materials.

The technique improves the detection of targets by an active sensor utilising physical properties of the return signal, thereby overcoming the problems of existing systems.

Accordingly, such apparatus and methods reduce the impact of noise in the system. This correlation technique works by correlating the return radiation with modulation of the initially emitted radiation to limit the frequency spectrum of the noise to a very low bandwidth. The technique may be digital for example, by emitting a known modulation sequence, or analogue for example, by modulating the signal with a known frequency. An example of a known digital technique is code division multiplexing that has been used in the mobile phone industry. An instance of an analogue technique is known as lock-in amplification or phase sensitive detection and has been used in other fields.

The invention will now be described with reference to the accompanying diagrammatic drawings in which:

FIG. 1 is a schematic drawing showing an illuminator and detector in accordance with one form of the invention, the illuminator illuminating the scene with radiation of a known and predetermined wavelength, the scene containing a target;

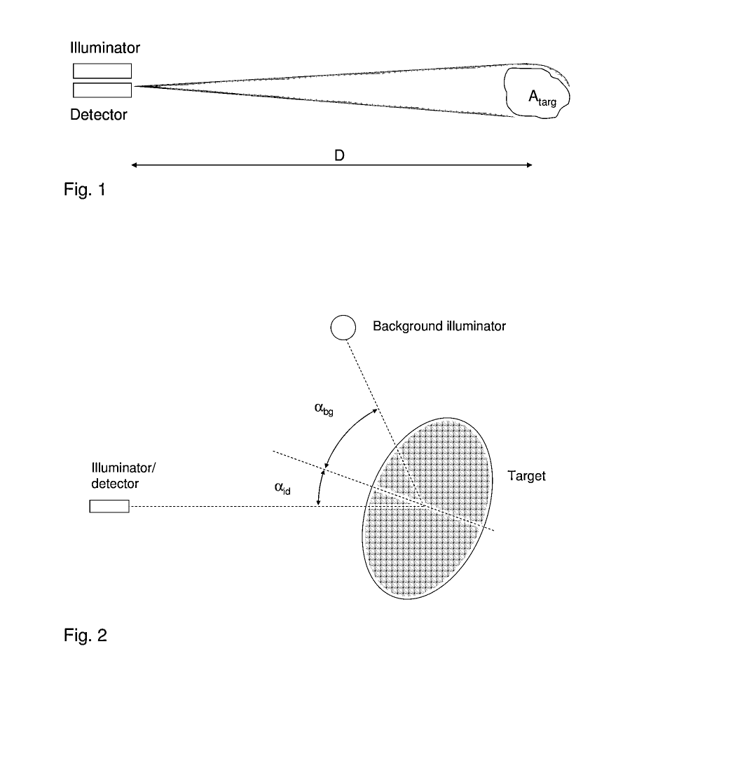

FIG. 2 is a schematic drawing showing the orientation of the target to the illuminator and a background light source; and

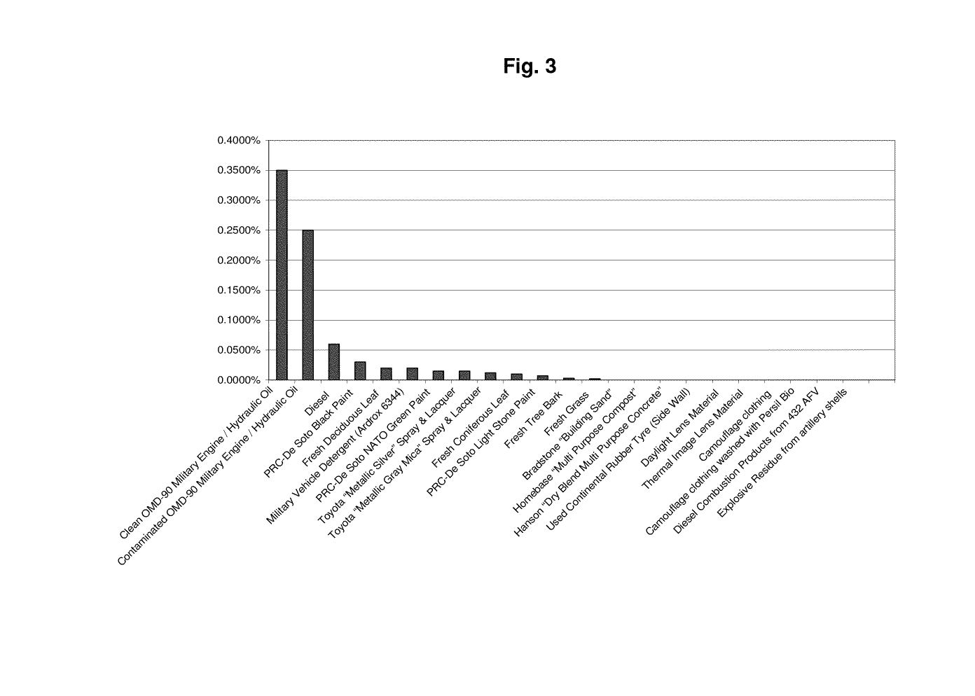

FIG. 3 is a graph showing quantum yields of typical target and clutter materials (expressed as percentage relative to Rhodamine 6G)—these quantum yield values also have to be scaled upwards according to the relative spectral bandwidths of the material with respect to Rhodamine-6G.

Luminescence is a property of a material whereby, following excitation by a photon, the material will emit a photon of longer wavelength. The shift in wavelength is termed the Stoke's shift after George Stokes who first wrote about the phenomenon of fluorescence in 1852. Luminescence covers both fluorescence and phosphorescence, but for the purpose of this application it is not necessary to distinguish between the two and the term fluorescence in its more general sense will be used.

Most chemical species will fluoresce under the right circumstances; however some species may exhibit a greater fluorescence quantum yield than others. Fluorescent emissions from a material provide information on the chemical species present within the material, which can then be exploited to classify the composition of the material. Results have shown that man made objects can be distinguished from natural vegetation by differences in their fluorescence emission spectra. Chlorophyll occurring in vegetation tends to have a spectrum in the 685-740 nm band with lower wavebands for man made materials, paint and fuel contamination.

As shown in FIG. 1, the system comprises an illuminator 1 and a detector 2 that are collocated and orientated along a common optical axis. In this embodiment the assumed propagation medium is mid-latitude, ground level atmosphere during summer with visibility of 23 km with a free standing target.

In use, the target area is illuminated using a radiation source of a known wavelength, wavelengths or range of wavelengths and a filtered detector or spectrometer at the radiation source position measures the returned light signal.

Natural materials (namely plant material) fluoresce at red end of spectrum and common man-made materials typically fluoresce at far-UV and blue end of spectrum. In this way, it is possible to discriminate man made targets from background natural materials.

In this way, a simple spectral method can be used to distinguish typical man-made materials from natural materials. Furthermore, a low pass optical filter may be sufficient. It has been found that natural material samples (vegetation/foliage) fluoresce at approx 750 nm with illumination optimum above 450 nm and man made samples (paint, oil) fluoresces at approx <350 nm with optimum illumination below 300 nm.

The power calculation for such apparatus can be split into convenient aspects as follows.

The illuminator 1 is transmitting radiation with power, Plas, a central wavelength of λlas and a full-width half maximum line-width of FWHMlas, the subscript ‘las’ is used on the assumption that the illuminator 1 is a laser, although other radiation sources may be envisaged. The transmission of the front end optics of the illuminator, Tol, is estimated as 95%.

The divergence of the radiation beam is a parameter that will influence the power density on the target and may be controllable depending on the application. The laser divergence angle (θlas) produces a spot at target distance (D) of area:

$$A = π . {[ D . tan ( \frac{{θ}_{las}}{2} ) ]}^{2} \qquad \{ 1 \}$$

Within this example, θlas=2.5 mrad, which illuminates an area of ˜5 m² at a distance of 1 km. For simplification it is assumed that the illuminance is radially uniform.

The transmission path is sea level mid-latitude air during summer with a 23 km visibility. This is a typical ‘good visibility’ assumption often used in optical transmission models for imaging applications. The atmospheric optical transmission per kilometre, Tatm, is shown in FIG. 2.

The key features in the atmospheric absorption are the increasing absorption of high energy (short wavelength) photons due to electronic excitation (Rayleigh scattering) and the longer wavelength absorption resulting from excitation of rotational/vibrational transitions in molecules. The molecular transitions dominate in the far visible and near IR spectrum and the extent of these effects will depend on the quantity of these molecules present, as such the absorption characteristics will change with humidity and in urban areas where pollution may become more significant.

The effect of poor visibility tends to dominate the longer wavelength of the visible spectrum (for example through increased water vapour content in the air) and has a lesser effect on the short wavelength end of the visible spectrum.

The target 3 is located a distance, D, from the illuminator 1 and assumed to be a diffuse (Lambertian) reflector with a cross-sectional area (as viewed by the detector) of Atarg and a uniform flat surface whose plane is orientated at an angle of αid to the optical axis of the illuminator.

The target will reflect a portion of the incident radiation in-band with a reflectance, Rillum, at the illuminator wavelength, the amount of radiation reflected will depend on the material. Some materials will reflect more radiation than others, for example it is known that many flowers are good reflectors of UV light, yet leaves typically are not. It is therefore assumed that an arbitrary estimate for all materials to reflect is 10% of the UV light (this value has been approximated based upon typical material reflectances in the UV to visible bands).

The remainder of the UV light will be absorbed and available for re-radiation as fluorescence (in a ratio determined by the quantum yield) at wavelength, λfl [symbol] . The spectrum of the fluorescence is largely independent of the illuminating photons (Kasha's rule) as long as the exciting photon has higher energy than the emitted photon. In order to assess the overall power budget of the system an arbitrary approximation of FWHM [symbol] =20 nm (approximated from experimental results) is used.

The Quantum yield of the fluorescence process, QY, will be a parameter of the target material type.

In practice, these quantum yields are an underestimate of the retro-reflected fluorescence as these values are peak rather than spectrally integrated and the fluorescence bandwidth is typically wider than the illumination bandwidth. To account for this in this model we use the integrated area under the fluorescence spectrum and scale the values accordingly. Assuming the spectrum of the fluorophore to be Gaussian in shape, following the form:

$$P ( λ ) = P * {e}^{( \frac{- {( λ - {λ}_{peak} )}^{2}}{\frac{{FWHM}^{2}}{4 ln ( 2 )}} )} \qquad \{ 2 \}$$

Where λpeak is the peak wavelength and FWHM the full-width half-maximum linewidth. The integrated area under the Gaussian is calculated.

Making the assumption that the illuminating source linewidth is <<1 nm, then the quantum yields need to be corrected by the ratio of the linewidths of the fluorescing species to the control species (Rhodamine 6G).

Fluorescence lifetime is not considered in this model, the source is assumed to be continuous at this stage and the target material is assumed to be in equilibrium. Non-radiative scattering mechanisms may not be considered.

Much of the fluorescence will occur within and around the visible spectrum and therefore sunlight will exhibit itself as a significant source of in-band clutter. The three cases of background illumination considered in this model are: solar, lunar and none (similar to a moonless night with no man-made illumination and negligible starlight irradiance). Background irradiance will be represented in the model as Ebackground, with the data obtained from [2].

Direct overhead sunlight at the equator represents the worst case for naturally occurring background light and as such is used in this model to estimate worst-case performance.

As with solar radiation, lunar irradiance when the moon is full and directly overhead can also act as background irradiance. The clutter received from purely lunar source is more than 5 orders of magnitude smaller than that of the solar source.

For the final class of no background illumination, the background level is zero.

The characteristics of the detector 2 and any associated camera will evidently have a dominant impact on the ability to detect UV fluorescence or other reflected radiation from distant sources. Key to the detectability will be the noise characteristics of the detector 2 and the ability to filter out clutter from background sources. The treatment of noise requires an in-depth study that accounts for the detection mechanism (e.g. phase synchronous detection [PSD]), noise from additional electronics and electronic filtering. In this model, the receiver exhibits a noise performance modelled as a Noise Equivalent Power (NEP) using a typical value for visible photodetectors of 10-14 W/√Hz. Receiver parameters used in this embodiment are as follows, but it will be appreciated that any receiver with suitable parameters may be used;

| | | |
|---|---|---|
| Detector active dimension (Ddet) | 100 | μm |
| Focal length (Fl) of the lens | 200 | mm |

| | |
|---|---|
| f number | 1.4 |
| Transmission of the optics (Trx) | 0.95 |

The aperture of the camera lens is therefore:

$${A}_{o} = \frac{Focallength}{f number} \approx 140 mm$$

With no spectral filtering within the camera, the area, at target range, seen by the detector 2 is:

$${A}_{det} = {( \frac{{D}_{det} \cdot D}{Fl} )}^{2} \qquad \{ 4 \}$$

Which using the above figures gives a detection area at 1 km of ˜5 m2. Clearly, in a practical implementation, the focal length and aperture may be constrained by available space on the platform. A seeker application, for example, may not be able to support such a wide aperture lens.

In a further embodiment of the invention further methods are described where the operation range of the system is extended. In the first method, the instantaneous energy of the illuminator is increased by using a pulsed illumination system and the background light incident upon the detector is reduced by gating the receiver. In a further technique, the effective noise floor of the detector is lowered by using a phase synchronous detection technique.

To estimate the range enhancement through pulsed operation the following characteristics may be used, although it will be appreciated that any suitable characteristics may be used: Laser pulse width of 100 ns; Laser pulse energy 1000 mJ; Laser pulse repetition rate 100 s-1; Receiver gate time 10 μs; Receiver gate repetition rate 100s-1. The receiver gate repetition rate must be at a rate sufficient to provide the image update rate needed for a seeker application; in this case the rate is set to 100 frames per second.

The effect of gating the receiver considerably reduces the amount of background light captured by the detector. For the above examples we see a noise limited range performance out to −3.2 km and −2.4 km respectively. Furthermore the effect of detector noise is now negligible at ranges below −4 km.

The method above of pulsed operation improves the signal and reduces the background radiation, yet does not impact the noise floor in a positive way. The technique of phase synchronous detection enables a lowering of the effective noise through modulation of the illumination signal and subsequent detection of that signal mixed with a delayed version of the modulation source.

PSD is considered here only in a qualitative sense. PSD enables the recovery of signals in potentially very large amounts of surrounding noise as only the noise that is in-band of the carrier frequency that will affect the SNR. In addition to a low frequency modulation (<<1 MHz) of the illuminator there will be an additional overhead in the receiver of a four-quadrant mixer. As such, a PSD system might be more suited to a large area detection system than to an imaging solution.

Such apparatus and methods could be used in acquisition and aimpoint refinements when targeting objects hiding in vegetation or urban environments. The apparatus could use a laser and sensor to illuminate the scene and discriminate the target. If a pulsed laser of sufficient energy and useful wavelength can be combined with a sensitive detector in the correct band then anomaly detection algorithms will allow the apparatus aimpoint to be refined onto the anomaly. Such apparatus would have use in border control situations.

However, it will be appreciated that there are many situations that may benefit from the above apparatus and technique.

This technique also uses free space propagation of the beams i.e. there is no light guide means and the beams propagate through air space.

1. Apparatus for detecting a target from within a scene comprising radiation-generating means for generating radiation and emitting said radiation toward the target, the radiation being of a known and predetermined wavelength, detector means for detecting the radiation returned by the target towards the detector, evaluation means for evaluating the radiation incident on the detector means wherein the detector means further includes a mechanism for modulating the emitted radiation such that the radiation reflected by the target may be more easily discriminated from background noise.

2. An apparatus according to claim 1 in which the predetermined wavelength comprises multiple discrete wavelengths or a wavelength range.

3. Apparatus according to claim 1 in which the emitted radiation comprises UV radiation and the radiation returned by the target comprises UV fluorescence of a range of wavelengths, said wavelengths returned being characteristic of the target or background, thereby enabling discrimination of target from background.

4. Apparatus according to claim 1 in which the emitted radiation comprises a pulse of radiation.

5. Apparatus according to claim 1 in which the detector means comprises a receiver that is gated such that the level of returned radiation attributable to background information is reduced.

6. Apparatus according to claim 1 in which the emitted radiation propagates towards the target through free air.

7. A method of detecting a target from within a scene comprising the steps of emitting radiation from a suitable radiation emitter; detecting radiation returned by the scene; discriminating the target from the scene by monitoring the returned radiation for responses characteristic of known target materials.

8. A method according to claim 8 in which the radiation comprises UV radiation and the returned radiation comprises UV fluorescence.

9. A method according to claim 7 in which the radiation emitted comprises a concentrated pulse of radiation.

10. A method or apparatus according to claim 1 in which the detected radiation is detected using phase sensitive detection means.

11. Apparatus for detecting a target from background within a scene comprising illuminating means for illuminating the scene with radiation and detector means for detecting returned radiation wherein the detector means includes gated receiver means such that radiation returned by the background is reduced.

12. (canceled)
